(19) United States
(12) Patent Application Publication
(10) Pub. No.: US 2025/0004732 A1
(43) Pub. Date: Jan. 2, 2025

(54) OPTIMIZATION OF ATTRIBUTE ACCESS IN PROGRAMMING FUNCTIONS

(71) Applicant: BMC Software, Inc., Houston, TX (US)

(72) Inventor: Duncan Paul Grisby, Cambridge (GB)

(21) Appl. No.: 18/345,878

(22) Filed: Jun. 30, 2023

(51) Int. Cl. G06F 8/41

(52) U.S. Cl. CPC G06F 8/4432; G06F 8/427; G06F 8/4441

(57) ABSTRACT

Systems and techniques for optimizing attribute accesses include receiving a first data structure, the first data structure including a first sequence of statements representing programming functions having an input and an output. The first sequence of statements is parsed to collect attribute accesses defined in the first sequence of statements. The first data structure and the first sequence of statements defining the attribute accesses are transformed to a second data structure including a second sequence of statements representing the programming functions having the input and the output, where the second sequence of statements defines a smaller number of the attribute accesses than the first sequence of statements. The second data structure is output, where the second data structure including the second sequence of statements generates a same output result as the first data structure including the second sequence of statements when executed by the at least one computing device.

### TECHNICAL FIELD

This description relates to the optimization of attribute access in programming functions.

### BACKGROUND

A programming language allows a programmer to access data attributes of objects as part of programming code. In some cases, these objects can be remote objects, meaning that the objects and the attributes of these objects are accessed across a network. Each attribute access to retrieve attributes across the network adds to network latency. It is desirable to implement systems and techniques that reduce the network latency.

### SUMMARY

According to some general aspects, a computer program product for optimizing attribute accesses may be tangibly embodied on a non-transitory computer-readable storage medium and may include instructions. When executed by at least one computing device, the instructions may cause the at least one computing device to receive a first data structure, the first data structure including a first sequence of statements representing programming functions having an input and an output. The first sequence of statements is parsed to collect attribute accesses defined in the first sequence of statements. The first data structure and the first sequence of statements defining the attribute accesses are transformed to a second data structure including a second sequence of statements representing the programming functions having the input and the output, where the second sequence of statements defines a smaller number of the attribute accesses than the first sequence of statements. The second data structure is output, where the second data structure including the second sequence of statements generates a same output result as the first data structure including the second sequence of statements when executed by the at least one computing device.

According to other general aspects, a computer-implemented may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for optimizing attribute access.

FIG. 2 is a flowchart illustrating example operations of the system of FIG. 1.

FIG. 3 is a block diagram of an example implementation of the optimizer of FIG. 1 in a compiler system.

FIG. 4 is a block diagram of an example implementation of the optimizer of FIG. 1 in a pre-compiler system.

### DETAILED DESCRIPTION

Described systems and techniques optimize programming code by reducing object accessor methods and, at the same time, maintain functional parity of the programming code and reduce network latency. The systems and techniques automatically scan the programming code, identify object accessor methods, and transform the programming code to reduce the number of object accessor methods, where the transformed programming code includes the same functional output as the original programming code.

For example, below is a fragment of programming code (in pseudo-code form):

Pseudo-code 1

```
function example(obj_1, obj_2)
  item_type = obj_1.type
  label  = item_type + “:” + obj_1.name
  size  = calculate(obj_1.size, obj_2.size, obj_2.extra)
  . . .
```

In the example Pseudo-code 1, each use of the “.” operator represents an attribute access. The example Pseudo-code 1 accesses three attributes of obj_1 (“type”, “name” and “size”) and two attributes of obj_2 (“size” and “extra”). When evaluating the code as written, the system makes five network round-trips to retrieve the five attribute values. The system is latency bound on the network latency between the executing code and the remote objects providing the attribute values. In this example, the described systems and techniques scan the Pseudo code 1, identify the accessor methods, and transform the Pseudo code 1 to a different pseudo code that enables the attributes to be retrieved in batches, either one batch for each object, or potentially a single batch for both objects. For example, the Pseudo-code 1 may be transformed into the below Pseudo-code 2.

Pseudo-code 2

```
function example(obj_1, obj_2)
  item_type, x_1, x_2 = obj_1.[type, name, size]
  label  = item_type + “:” + x_1
  x_3, x_4 = obj2.[size, extra]
  size  = calculate(x_2, x_3, x_4)
  . . .
```

The optimizing transform applied to the Pseudo-code 1 is done without a programmer having to re-code the Pseudo-code 1 to reduce the attribute accesses. The Pseudo-code 1 bound a name (“item_type”) to the “type” attribute of obj_1, but all the other attribute uses were anonymous accesses where the attribute values were used as parts of larger expressions. The optimizing transform introduces extension name bindings for these otherwise anonymous values, shown in the example in the form x_1. The transformed Pseudo-code 2 reduces the number attribute access from five network round-trips to retrieve the five attribute values to two network round-trips to retrieve the five attribute values. In this manner, network efficiency and network latency are improved. The systems and techniques improve network latency through function call aggregation. The above example is a simple Pseudo-code example for purposes of illustration. As described in more detail below, the described systems and techniques may transform and optimize more complex programming code including, for example, programming code that includes aliasing and name rebinding, attribute value assignment, branches, loops, data races, as well as other programming code.

In some examples, the described systems and techniques may be implemented as part of a compiler (e.g., a language compiler). In these examples, the code transformation takes place within the compiler. In some examples, the described systems and techniques may be implemented as part of a different component such as, for example, a pre-compiler. In these examples, the code transformation takes place outside of the existing language compiler.

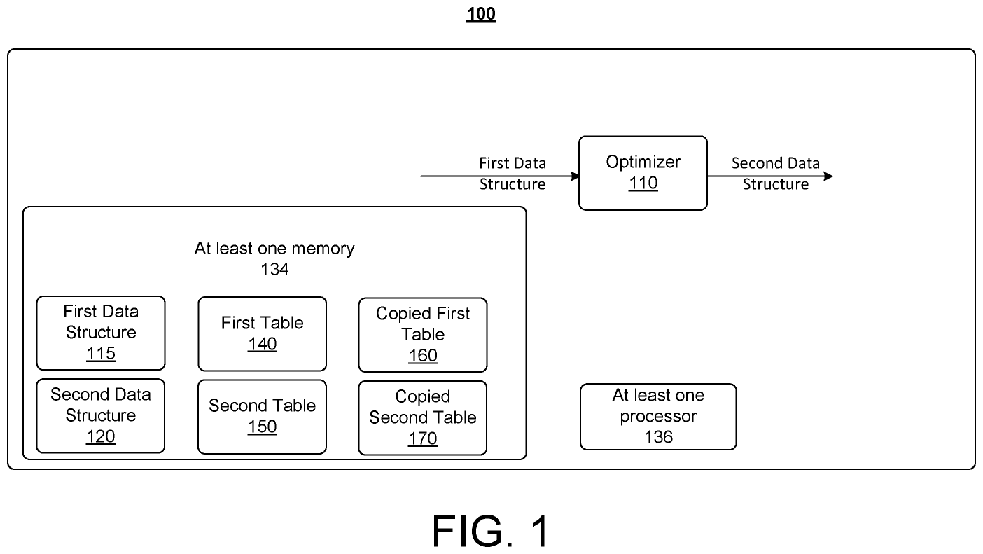

FIG. 1 is a block diagram of a system 100 for optimizing attribute access. The system 100 is representative of a computing system including a computing device or multiple computing devices operating together. The system 100 includes an optimizer 110, at least one memory 134, and at least one processor 136. The optimizer 110 is configured to receive a first data structure 115, transform the first data structure 115 by reducing the number of attribute accesses defined by the first data structure 115, and outputting a second data structure 120 that defines a smaller number of attribute accesses than the first data structure 115. At the same time, the second data structure 120 generates a same output result as the first data structure 115 when executed by the system 100 and the at least one processor 136. In this manner, a first data structure 115, which may be the result of programming by a programmer, is automatically transformed by the optimizer 110 to the second data structure 120 without the programmer re-writing or otherwise re-programming the first data structure 115. The at least one memory 134 may store the first data structure 115 and the second data structure 120.

In FIG. 1, the first data structure 115 includes a first sequence of statements representing programming functions having an input and an output. The first sequence of statements may correspond to a programming language that a programmer has programmed. The first sequence of statements may include attribute accesses, which are values of attributes for an object or objects. In some instances, the attribute accesses are remote attribute accesses that are accessed across a network. The attribute accesses include a request for the value of the attribute and a response to the request that returns the value of the attribute. For a remote attribute access, the request and the response are each transmitted over a network. In the example above, Pseudo-code 1 included five remote attribute accesses (e.g., three attributes of obj_1 (“type”, “name” and “size”) and two attributes of obj_2 (“size” and “extra”)).

The first data structure 115 may be an abstract syntax tree (AST) or an intermediate representation (IR), which are types of data structures that are representative of the sequence of statements of a programming language. For example, the IR is a form that is suitable for code generation. In a similar manner, the second data structure 120 is also an AST or an IR, which is representative of a sequence of statements of a programming language.

The sequence of statements may include a large number of different types of statements including, for example, “If” statements, “For” statements, as well as other types of statements that are written in a programming language. For example, the sequence of statements may include variable assignment statements, where a variable is assigned a value. For example, the sequence of statements may include scope assignment statements, where an attribute of a local or remote object is assigned a value. For example, the sequence of statements may include “If” statements consisting of a number of branches, where each branch has a condition expression and a sequence of statements for that branch. For example, the sequence of statements may include “For” statements that specify a loop variable, which is an expression to iterate over, and a sequence of statements for the loop body.

Many sequences of statements involve expressions, which are representations of how to construct values. For example, expressions may include variable access expressions. Expressions may include scope access expressions, where an attribute of a local or remote object is accessed. Expressions also may include arithmetic and logical operations (ANDs and ORs) and function calls.

In the first data structure 115, the original programming language sequence of statements, including the expressions, may already have been modified. For example, the sequence of statements and expressions may have been annotated with information for use in any later transformations. For examples, variable attribute accesses in expressions may have been classified with the type of variable including information of whether the variable definitely or possibly corresponds to a remote object. Function calls may have been classified as to whether the call is short-running or long-running. Functions may have been annotated as to whether the functions ever assign values to remote object attributes. These annotations and other information related to the modified sequence of statements may be stored in the at least one memory 134.

After the optimizer 110 receives the first data structure 115, which includes the first sequence of statement representing programming functions having an input and an output, the optimizer 110 parses the first sequence of statements to collect attribute accesses defined in the first sequence of statements. Then, the optimizer 110 transforms the first data structure 115 and the first sequence of statements defining the attribute accesses to a second data structure 120 including a second sequence of statements representing the programming functions having the same input and the same output. That is, the second data structure 120 maintains the same programming functions, including the same input and the same output, as the first data structure 115. Advantageously, the second sequence of statements defines a smaller number of attribute accesses than the first sequence of statements. In this manner, the network efficiency and the network latency are improved because of the smaller number of attribute accesses. As a result of the code transformation from the first data structure to the second data structure, the optimizer 110 reduces the number of round-trip attribute accesses across the network. The optimizer 110 outputs the second data structure 120, which generates a same output result as the first data structure 115 when executed by the at least one processor 136, but with fewer attribute accesses than the first data structure 115.

In some examples, the optimizer 110 implements an optimization transform that works by making two passes over the first sequence of statements from the first data structure 115. For example, in the first pass, the optimizer 110 records information about attribute accesses in the at least one memory 134. Then, in the second pass, the optimizer 110 uses that collected information to transform the IR statements and expressions accordingly.

In addition to the first data structure 115 and the second data structure 120, the at least one memory 134 includes two main data structures: a first table 140 and a second table 150. The first table 140 includes a mapping from variable names to a generation number for the variable. The second table 150 includes a mapping from pairs of variable name and generation number to names of attributes read from them and, if pertinent, the variable names the attributes are assigned to, plus a flag to indicate if the variable is a loop variable.

In the first pass over the statements, the optimizer 110 parses and considers all expressions within the first data structure 115. When a variable is assigned to a value that may correspond to a remote object, if there is an entry in the first table 140, the generation number is incremented. If there is no entry in the first table 140, an entry is created and entered into the first table 140 with a generation number of zero.

During the first pass, any attribute access from a variable that may correspond to a remote object is added to the second table 150 using the variable's current generation number from the first table 140. If a call is made to a function that is asynchronous or that assigns to remote attributes, all the generation numbers in the first table 140 are incremented. In this manner, the optimization does not span across such calls. If an assignment is made to a remote attribute, all the generation numbers in the first table 140 are incremented.

During the first pass, the optimizer 110 is also configured to optimize attribute accesses in loop statements. When a loop statement is encountered, the loop variable is added to the second table 150 and the flag is set to mark that the variable is a loop variable. The statements in the loop body are handled by recursively applying this algorithm of adding all the attribute accesses and variable assignments to the first table 140 and the second table 150.

During the first pass, the optimizer 110 is also configured to optimize attribute accesses in “if” statements. When an “if” statement is encountered, for each branch, the current tables in the at least one memory 134 (i.e., the first table 140 and the second table 150) are copied such that there is a copied first table 160 and a copied second table 170. During the first pass, the optimizer 110 recursively applies the algorithm of adding all attribute accesses and variable assignments for all the statements in the branch using the copied first table 160 and the copied second table 170.

The original set of tables (i.e., the first table 140 and the second table 150) and the copied tables (i.e., the copied first table 160 and the copied second table 170) from each branch are compared. If the original tables and the copied tables are not all identical, the optimizer 110 combines the tables. For example, if the same attributes from the same pairs (variable name, generation) are retrieved in all branches, the change is applied to the original tables (i.e., the first table 140 and the second table 150).

If there are differences in attributes' generation numbers, the generation numbers in the first table 140 for the attributes in question are set to one more than the maximum generation from any of the branches, which prevents the optimization from incorrectly applying to other statements encountered outside the “if” statement. If branches retrieve different attributes from a particular (variable name, generation) pair, but there are only a small number of differences (e.g., up to three differences), the union of the attributes is applied to the second table 150. Otherwise, the changes are not applied to the second table 150, but the copied first table 160 and the copied second table 170 are retained for the second pass by the optimizer 110.

Following the first pass through the first data structure 115, the optimizer 110 performs a second pass over the first data structure 115. When a scope access for a remote object is encountered in an expression, the entry in second table 150 is checked. If this is the first time the (variable name, generation) pair has been encountered and it is not a loop variable, a new assignment statement is injected before the current statement. The assignment sets a variable for each of the retrieved attributes using a bulk data retrieval operation. The variables that are assigned are either the names that were assigned in the original input code or generated names for anonymous expressions. All uses of scope access for the (variable name, generation) are replaced by use of the corresponding variable.

When a loop is encountered, if the loop expression contains remote objects, the loop variable is looked up in second table 150 to find the attribute names that are retrieved from it. For each attribute name, variable names to hold the attributes are chosen as in the non-loop case above. The loop expression is replaced with an expression that performs and returns a bulk data retrieval for all the required attributes from all the objects in a single operation. The loop variable is replaced with a collection of variables corresponding to the object itself followed by the chosen variable for each of the retrieved attributes. The optimizer 110 recursively executes this algorithm for the loop body thus replacing all attribute lookups on the loop variable with the bulk-retrieved values.

For example, when an “if” statement is encountered, the optimizer 110 recursively executes the algorithm for the body of each branch, using the copied first table 160 and the copied second table 170 as updated for that branch during the first pass.

During the second pass, the optimizer 110 transforms or modifies the first data structure 115 to replace each of the optimizable remote accesses with suitable bulk accesses and uses of bulk-retrieved values, which results in the second data structure 120. That is, the second data structure 120 now includes bulk attributes accesses and uses bulk-retrieved values to reduce the number of attribute accesses when compared to the number of attribute accesses in the first data structure 115. As mentioned above, the output result of the second data structure 120 is the same as the output result of the first data structure 115.

In some examples, the optimizer 110 may use some simplifying assumptions when making passes through the first data structure 115. For example, the optimizer 110 may not permit the optimization to span assignment to any attribute, either directly or in a called function. Although it would be possible to track which attribute names are assigned, and only invalidate optimization of those ones, experience with real world code shows that there are very few cases where this makes any difference, and so some example implementations may avoid the additional complexity of tracking it. Additionally, the optimizer 110 may opt not to track aliasing, where one variable is assigned to another, meaning that some optimizations that could be applied are not. This may be done based on an analysis of code, which shows that such aliasing almost never occurs.

The at least one processor 136 may represent two or more processors executing in parallel and utilizing corresponding instructions stored using the at least one memory 134. The at least one processor 136 may include at least one CPU. The at least one memory 134 represents a non-transitory computer-readable storage medium. Of course, similarly, the at least one memory 134 may represent one or more different types of memory utilized by the system 100. In addition to storing instructions, which allow the at least one processor 136 to implement the system 100 and the optimizer 110 and other various components, the at least one memory 134 may be used to store data and other information used by and/or generated by the system 100 and the optimizer 110.

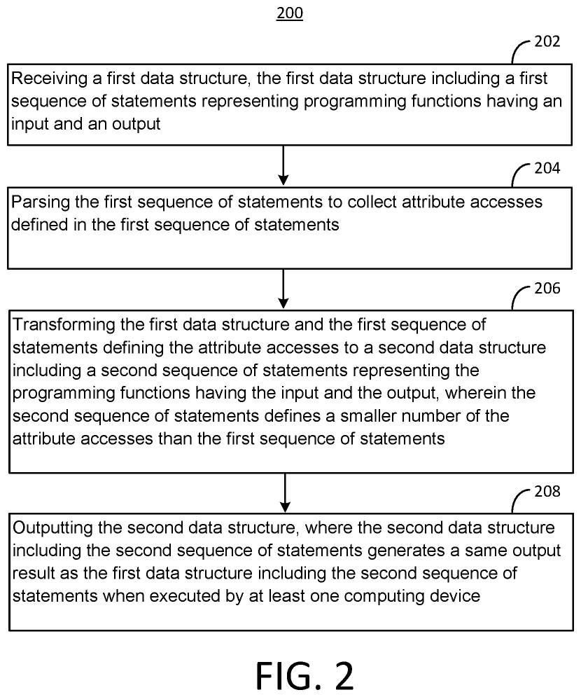

FIG. 2 is a flowchart illustrating an example process 200 for example operations of the system 100 of FIG. 1. Process 200 is a computer-implemented method that may be implemented by the system 100 and its components, including the optimizer 110. Instructions and/or executable code for the performance of process 200 may be stored in the at least one memory 134, and the stored instructions may be executed by the at least one processor 136. Process 200 is also illustrative of a computer program product that may be implemented by the optimizer 110.

Process 200 includes receiving a first data structure, the first data structure including a first sequence of statements representing programming functions having an input and an output (202). For example, the optimizer 110 of FIG. 1 is configured to receive the first data structure 115, where the first data structure 115 includes a first sequence of statements representing programming functions having an input and an output, as discussed above.

Process 200 includes parsing the first sequence of statements to collect attribute accesses defined in the first sequence of statements (204). For example, the optimizer 110 of FIG. 1 is configured to parse the first sequence of statements to collect attribute accesses defined in the first sequence of statements. In some examples, the optimizer 110 parses the first sequence of statements by traversing the first sequence of statements in a first pass. The information for the attribute accesses is recorded in the at least one memory 134 during the first pass.

Process 200 includes transforming the first data structure and the first sequence of statements defining the attribute accesses to a second data structure including a second sequence of statements representing the programming functions having the input and the output, where the second sequence of statements defines a smaller number of the attribute accesses than the first sequence of statements (206). For example, the optimizer 110 is configured to transform the first data structure 115 and the first sequence of statements defining the attribute accesses to the second data structure 120 including the second sequence of statements representing the programming functions having the input and the output, where the second sequence of statements defines a smaller number of the attribute accesses than the first sequence of statements. That is, the second data structure 120 has the same programming functions with the same input and the same output as the first data structure 115, but with fewer attribute accesses.

In some examples, the optimizer 110 transforms the first data structure 115 and the first sequence of statements by traversing the first sequence of statements in a second pass using the information for the attribute accesses recorded in the at least one memory 134. More specifically, the information for the attribute accesses in the at least one memory 134 may include the first table 140 having a first mapping from a variable name to a generation number for a variable corresponding to the variable name. The information also may include the second table 150 having a second mapping from pairs of the variable name and the generation number to names of attributes read from the pairs. In some examples, the information also includes the copied first table 160 and the copied second table 170 for use when parsing and transforming the first sequence of statements when “if” statements and other expressions are included.

Process 200 includes outputting the second data structure, where the second data structure including the second sequence of statements generates a same output result as the first data structure including the second sequence of statements when executed by the at least one computing device (208). For example, the optimizer 110 of FIG. 1 is configured to output the second data structure 120, where the second data structure 120 including the second sequence of statements generates a same output result as the first data structure 115 including the second sequence of statements when executed by at least one computing device. In some examples, the attribute accesses include remote attribute accesses.

In some examples, the first sequence of statements includes a loop expression and the process 200 may transform the first data structure and the first sequence of statements to the second data structure and the second sequence of statements by augmenting the loop expression with a bulk expression that performs and returns a bulk data retrieval for the attribute accesses in a single operation. In some examples, the loop expression includes a loop body and the process 200 may recursively replace all the attribute accesses in the loop body with values from the bulk data retrieval.

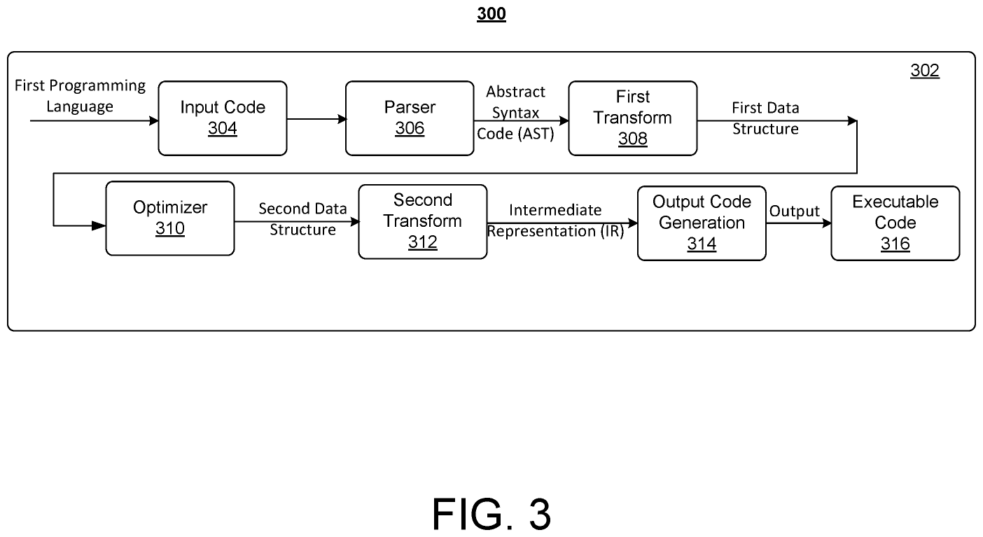

As mentioned above, the optimizer 110 may be implemented in various different contexts. For instance, the optimizer 110 may be implemented as part of a compiler system. FIG. 3 is a block diagram of an example implementation of the optimizer of FIG. 1 in a compiler system 300. The compiler system 300 includes a compiler 302. The compiler 302 receives a first programming language as input code 304. The input code 304 is parsed by a parser 306 and outputs an AST data structure. The AST is transformed by a first transform 308 and outputs a first data structure. The first data structure is the same as the first data structure 115 of FIG. 1.

The first data structure is input to an optimizer 310. The optimizer 310 includes the same features and functionality as the optimizer 110 of FIG. 1. The optimizer 310 performs the process 200 of FIG. 2 on the first data structure and outputs a second data structure, which is the same as the second data structure 120 of FIG. 1. The second data structure is transformed by a second transform 312 to an IR that is processed by output code generation 314 to produce output in the form of executable code 316. In some examples, the executable code 316 may be in a second programming language that is different than the first programming language, where the executable code 316 is ready for execution by a processor and/or a computing device. In this example, the optimizer 310 functions as another transformation stage within the compiler 302.

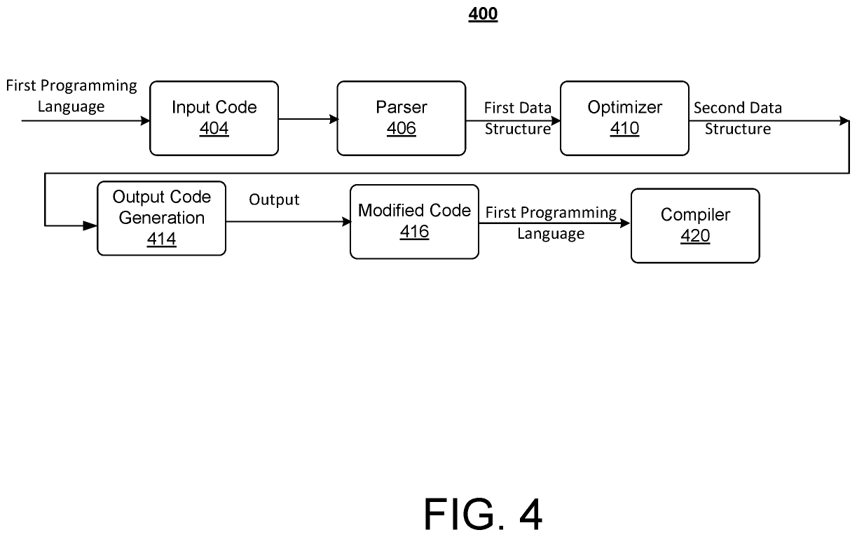

In some examples, the optimizer 110 of FIG. 1 may be implemented outside of a compiler such as part of a pre-compiler stage. FIG. 4 is a block diagram of an example implementation of the optimizer of FIG. 1 in a pre-compiler system 400. A first programming language is received as input code 404 that is then parsed by a parser 406 to output a first data structure. The first data structure is the same as the first data structure 115 of FIG. 1. The optimizer 410 receives and processes the first data structure as discussed above with respect to the optimizer 110 of FIG. 1 and the process 200 of FIG. 2 to output the second data structure.

The second data structure is processed by the output code generation 414 to output modified code 416 that is in the same first programming language that was received as the input code 404. This modified code 416 in the same first programming language is then input to a compiler 420.

While the above examples illustrate the technical solutions implemented in a compiler and a pre-compiler, the described systems and techniques are not limited to those examples. For instance, the described systems and techniques may be applied in other contexts and applications including as part of a web front end that accesses multiple data items from back-end servers, a microservice that accesses multiple data items from another web service via a remote procedure call (RPC) mechanism, and a client that accesses multiple data values from a persisted object in an object database.

As discussed in detail above, the described systems and techniques make the execution of the original input code significantly more efficient by transforming the code to reduce attribute accesses without requiring any changes to the original input code by the programmer. In this manner, when the attribute accesses are remote attribute accesses across a network, the network efficiency and the network latency are improved, which results in an overall improved computer network. The described systems and techniques allow the original input code to be written in a straightforward way without having to worry about the specifics of how data access is actually performed. This increases programmer productivity while leveraging the described systems and techniques to make efficient use of the network.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product for optimizing attribute accesses, the computer program product being tangibly embodied on a non-transitory computer-readable storage medium and comprising instructions that, when executed by at least one computing device, are configured to cause the at least one computing device to:
receive a first data structure, the first data structure including a first sequence of statements representing programming functions having an input and an output;
parse the first sequence of statements to collect attribute accesses defined in the first sequence of statements;
transform the first data structure and the first sequence of statements defining the attribute accesses to a second data structure including a second sequence of statements representing the programming functions having the input and the output, wherein the second sequence of statements defines a smaller number of the attribute accesses than the first sequence of statements; and
output the second data structure, wherein the second data structure including the second sequence of statements generates a same output result as the first data structure including the second sequence of statements when executed by the at least one computing device.

2. The computer program product of claim 1, wherein:
the first sequence of statements includes a loop expression; and
the instructions, when executed, are further configured to cause the at least one computing device to:
transform the first data structure and the first sequence of statements to the second data structure and the second sequence of statements by augmenting the loop expression with a bulk expression that performs and returns a bulk data retrieval for the attribute accesses in a single operation.

3. The computer program product of claim 2, wherein:
the loop expression includes a loop body; and
the instructions, when executed, are further configured to cause the at least one computing device to:
recursively replace all the attribute accesses in the loop body with values from the bulk data retrieval.

4. The computer program product of claim 1, wherein the instructions, when executed, are further configured to cause the at least one computing device to:
parse the first sequence of statements by traversing the first sequence of statements in a first pass;
record information for the attribute accesses in a memory during the first pass; and
transform the first data structure and the first sequence of statements by traversing the first sequence of statements in a second pass using the information for the attribute accesses recorded in the memory.

5. The computer program product of claim 4, wherein the information for the attribute accesses in the memory includes:
a first table comprising a first mapping from a variable name to a generation number for a variable corresponding to the variable name; and
a second table comprising a second mapping from pairs of the variable name and the generation number to names of attributes read from the pairs.

6. The computer program product of claim 1, wherein the attribute accesses include remote attribute accesses.

7. The computer program product of claim 1, wherein the instructions, when executed, are further configured to cause the at least one computing device to parse the first sequence of statements, transform the first data structure, and output the second data structure without user intervention.

8. A computer-implemented method for optimizing attribute accesses, the computer-implemented method comprising:
receiving a first data structure, the first data structure including a first sequence of statements representing programming functions having an input and an output;
parsing the first sequence of statements to collect attribute accesses defined in the first sequence of statements;
transforming the first data structure and the first sequence of statements defining the attribute accesses to a second data structure including a second sequence of statements representing the programming functions having the input and the output, wherein the second sequence of statements defines a smaller number of the attribute accesses than the first sequence of statements; and
outputting the second data structure, wherein the second data structure including the second sequence of statements generates a same output result as the first data structure including the second sequence of statements when executed by at least one computing device.

9. The computer-implemented method of claim 8, wherein:
the first sequence of statements includes a loop expression; and
the computer-implemented method further comprising:
transforming the first data structure and the first sequence of statements to the second data structure and the second sequence of statements by augmenting the loop expression with a bulk expression that performs and returns a bulk data retrieval for the attribute accesses in a single operation.

10. The computer-implemented method of claim 9, wherein:
the loop expression includes a loop body; and
the computer-implemented method further comprising:
recursively replace all the attribute accesses in the loop body with values from the bulk data retrieval.

11. The computer-implemented method of claim 8, the computer-implemented method further comprising:
parsing the first sequence of statements by traversing the first sequence of statements in a first pass;
recording information for the attribute accesses in a memory during the first pass; and
transforming the first data structure and the first sequence of statements by traversing the first sequence of statements in a second pass using the information for the attribute accesses recorded in the memory.

12. The computer-implemented method of claim 11, wherein the information for the attribute accesses in the memory includes:
a first table comprising a first mapping from a variable name to a generation number for a variable corresponding to the variable name; and
a second table comprising a second mapping from pairs of the variable name and the generation number to names of attributes read from the pairs.

13. The computer-implemented method of claim 8, wherein the attribute accesses include remote attribute accesses.

14. The computer-implemented method of claim 8, further comprising parsing the first sequence of statements, transforming the first data structure, and outputting the second data structure without user intervention.

15. A system for optimizing attribute accesses, comprising:
at least one processor; and
a memory storing instructions that, when executed by the at least one processor implements an optimizer that is configured to:
receive a first data structure, the first data structure including a first sequence of statements representing programming functions having an input and an output;
parse the first sequence of statements to collect attribute accesses defined in the first sequence of statements;
transform the first data structure and the first sequence of statements defining the attribute accesses to a second data structure including a second sequence of statements representing the programming functions having the input and the output, wherein the second sequence of statements defines a smaller number of the attribute accesses than the first sequence of statements; and
output the second data structure, wherein the second data structure including the second sequence of statements generates a same output result as the first data structure including the second sequence of statements when executed by the at least one processor.

16. The system of claim 15, wherein:
the first sequence of statements includes a loop expression; and
the optimizer is configured to:
transform the first data structure and the first sequence of statements to the second data structure and the second sequence of statements by augmenting the loop expression with a bulk expression that performs and returns a bulk data retrieval for the attribute accesses in a single operation.

17. The system of claim 16, wherein:
the loop expression includes a loop body; and
the optimizer is configured to:
recursively replace all the attribute accesses in the loop body with values from the bulk data retrieval.

18. The system of claim 15, wherein the optimizer is configured to:
parse the first sequence of statements by traversing the first sequence of statements in a first pass;
record information for the attribute accesses in a memory during the first pass; and
transform the first data structure and the first sequence of statements by traversing the first sequence of statements in a second pass using the information for the attribute accesses recorded in the memory.

19. The system of claim 18, wherein the information for the attribute accesses in the memory includes:
a first table comprising a first mapping from a variable name to a generation number for a variable corresponding to the variable name; and
a second table comprising a second mapping from pairs of the variable name and the generation number to names of attributes read from the pairs.

20. The system of claim 15, wherein the attribute accesses include remote attribute accesses.

21. The system of claim 15, wherein the optimizer is configured to parse the first sequence of statements, transform the first data structure, and output the second data structure without user intervention.
